(19) United States
(12) Patent Application Publication
(10) Pub. No.: US 2023/0188419 A1
(43) Pub. Date: Jun. 15, 2023

(54) REDUNDANT STORAGE OF CONFIGURATION OF NETWORK DEVICES

(71) Applicant: HIRSCHMANN AUTOMATION AND CONTROL GMBH, Neckartenzingen (DE)

(72) Inventor: Martin HOEGLINGER, Esslingen am Neckar (DE)

(21) Appl. No.: 17/784,360

(22) PCT Filed: Oct. 6, 2020
(86) PCT No.: PCT/EP2020/078015

§ 371 Date: Nov. 14, 2022

(30) Foreign Application Priority Data
Jan. 15, 2020 (DE) 102020100870.8

(51) Int. Cl. H04L 41/0853; H04L 41/0813; H04L 41/0893

(52) U.S. Cl. CPC H04L 41/0856; H04L 41/0813; H04L 41/0893

(57) ABSTRACT

The present invention relates to a method for distributing configurations of network devices (1, 2, 3, 4, 5, 6, 7, 8). Said network devices are connected to at least one network (11). At least two network devices (1, 2, 3, 4, 5, 6, 7, 8) are connected to the network (11) via ports (9). All of the network devices (1, 2, 3, 4, 5, 6, 7, 8) are moreover provided with a determinable unique identification, and at least one memory (10) assigned to at least one network device (1, 2, 3, 4, 5, 6, 7, 8) is used. This memory is embodied in addition to the local memory of each network device. According to the invention, at least one network device (1, 2, 3, 4, 5, 6, 7, 8) now has means for location determination that determine the location of the at least one network device (1, 2, 3, 4, 5, 6, 7, 8). The configuration of the at least one network device (1, 2, 3, 4, 5, 6, 7, 8) is then stored, according to the invention, in thememory (10) of another network subscriber (1, 2, 3, 4, 5, 6, 7, 8) by including the location. This configuration file can then be used to configure interchanged network devices.

The present invention relates to a method of distributing configurations of network devices. Such a distribution of configurations according to the invention can be used to automatically configure network devices without a configuration, for example, newly inserted replacement devices.

Many devices used in networks require, for proper operation, a configuration that is usually in the form of a configuration file, and normally this configuration is stored on the network device itself in a form that is stored in a non-volatile memory area from which the device is operated after a possible restart in order to return to the state before initiation of the restart.

If a device has to be replaced by a similar device because of a defect or other faulty behavior, the data stored on the device are often no longer available in order to be able to store them on the newly exchanged device. For this reason, according to the prior art, an external storage medium is used that, during operation, is connected to the device and on which the original or at least one copy of the configuration file is located.

In the event of a device being replaced, the external memory is connected to the new device and this new network device reads the configuration from the external storage medium in order to load the configuration of the swapped-out device so that its behavior corresponds to that of the network device to be replaced.

A disadvantage of this type of configuration of new devices, however, is that the use of additional components, for example an external memory, is absolutely necessary. Furthermore, the regular reading out of the network devices is time-consuming for any re-equipping of a network device with the corresponding configuration.

For this purpose, methods for self-configuration are known from the prior art, for example EP 0 241 878 [US 5109484] discloses a method of self-configuration in networks designed in a ring-like manner. In this case, it is determined which devices are present in the ring-like applied network, so that a corresponding request can be made when a device is replaced. For the configuration of the new device, a corresponding configuration must then be sent to the new device via the network.

WO 2008/082587 [US 8,024,000] discloses a further method of configuring network devices, wherein parameters for the proper use of the network are transmitted in this case. This is done on the basis of the requirement of the network device to be newly configured. Corresponding peripheral devices connected to the network device are not taken into account in this case.

The object of the present invention is therefore to provide a method of distributing configuration of network devices where the configuration is not only stored locally on the network device to be replaced but can also be retrieved and applied by an exchange device after the network has been connected.

The above-described object is achieved by the method having the features of the main claim. For this purpose, a method with at least one network is proposed, to which network devices can be connected. All types of devices that have a network connection are suitable as network devices, and this network connection could be wired or wireless. Thus, by way of example, computers, tablets, printers, scanners, routers, monitors or televisions may be mentioned as network devices.

The method according to the invention requires at least two network devices that are connected to the network via ports. For this purpose, the network devices can have a plurality of ports via which further peripheral devices are connected.

According to the invention, the network devices each have a determinable unique identifier. This may be a simple name, a MAC address or an ID

Finally, at least one of the network devices connected in the network has a memory. This memory can store and read out the required configurations of the network devices. These memories are nonvolatile and in addition to the local memories of the network devices.

According to the invention, the network device to be configured has means for location determination. This means serves for determining the location of this network device.

In particular, two methods are proposed for determining the location. Thus, the position determination can take place by a topological fingerprint in that the devices of the network device know which device was connected to the position to be configured.

A topological fingerprint is understood in this respect to be a character string that, for example, can be interpreted as a file name of a configuration file. The configuration of the device is then located as content in the file.

To create such a character string, it is proposed that the devices connected in the vicinity are determined and their unique identifiers are read. These are now stored as a character string one behind the other. This character string can then be used as a file name of the configuration file.

In a particular embodiment, the port numbers of the network device to be configured can also be read, to which the adjacent network devices are connected. The character string used in this way then consists of the used port numbers and the identifiers of the adjacent network devices and the port numbers they are connected to.

The character string thus generated, which serves as part of the file name of the configuration file may be interpreted to configure the configuration file

Network devices clearly create a special configuration file and initially store them locally. Storage of the configuration file in a memory of the further network devices is provided according to the invention.

As an alternative to the topological fingerprint, the adjacent network devices store their own identifiers, so that the adjacent network devices know the network device to be configured and its position can thereby be defined.

According to the invention, after determining the location of the network devices, its respective configuration is stored with inclusion of the location in the memory of another network device. In a particular embodiment, it may also be provided to access a particular network device or in the configuration is distributed so that it is subsequently present on a plurality of memories of the network devices.

The determination of the network device in whose memory the configuration is stored can take place according to certain rules. A rule could be, for example, to first select those neighbors that themselves have the fewest neighbors. As a result, it is not the case that the devices with many neighbors also have to store many configuration files.

After the appropriate candidate (network device) or candidates is/are selected for storage, the configuration file is transferred to the corresponding nonvolatile storage device(s) and stored there. The storage takes place in copy in addition to the local storage of the configuration file, as is known from the prior art. If a server is present in the network, it can also be established as a rule that the configuration files are stored centrally on the server.

The storage of the configuration files can take place according to a specified schedule or else each time a network device has a configuration change.

In the event of failure of a network device, it must be removed and replaced by a factory-fresh network device at the same location, so that all connections that had the defective device are again produced in exactly the same way, in this case the new device recognizes that it has no configuration and exchanges information with the further network devices in the network in order to find at its configuration file.

For this purpose, it is again proposed that the identification of the location, as mentioned above, is carried out. As described above, as a result, the corresponding configuration file is then specifically identified, so that the network device to be configured can now read and apply its configuration file.

The storage of the configuration files may be encrypted in a particular embodiment. It can also be compressed to save memory space. Compression and encryption may also be performed in combination.

A suitable point-to-point protocol (P2P) is proposed in order to realize the data exchange of the various network devices with one another. For this purpose, the configuration file to be stored is sent to the corresponding device by this protocol and is also read out again if necessary. Corresponding protocols for this purpose are sufficiently known from the prior art.

In a particular embodiment, it is proposed that at least one display is provided and parameters that can be shown on the display are generated for the states of the individual network devices. Thus, the state of the network devices and/or the configurations can be shown at any time on the display.

The parameters generated in advance may contain, in particular, how often and on which network devices a configuration is stored, whether the configuration files with the same name have the same content, the number of network devices involved in the method, free and occupied memories of the network devices and/or a table via adjacent network devices and their state.

In a particular embodiment, it is proposed to not store the configuration on general network devices, but centrally on a server. As mentioned above, the configuration files are then stored on the server according to a rule and retrieved therefrom.

In another embodiment, it is proposed to store the configuration not completely in a configuration file, but only to the extent that the rest of the still missing configuration data is loaded from a central location or other network devices. Thus, the configuration file is divided into a plurality of partial files and the latter are stored on a plurality of network devices.

In a further particular embodiment, it is proposed that the communication protocol is not only a P2P protocol, but that the extended neighborhood of network devices can also be included. This can be achieved by providing a protocol field, for example Transmission level containing (TTL-“time-to-live”).

The sender of the protocol message then sets this value to 2, for example, in order not to reach the next network device in the immediate vicinity of the sender, but the next device, the first receiver of the message and thus a direct neighbor of the sender checks whether the value contained in the message is greater than 1. If this is the case, it forwards the message to all other ports and at the same time reduces the TTL value by one.

The subsequent receiver of the message recognizes the 1 in the protocol and responds accordingly to the message. As a result, the transmitters of the message can each determine whether the direct neighbor or further remote network devices are to be queried or addressed.

If such a protocol field is used, the original TTL value must also be maintained in the protocol, so that in response to the corresponding network device precisely this value can be used for the protocol packets of the response in order to again reach the sender of the message in the reverse direction.

The advantages achieved with the invention consist in particular in that it is possible to dispense with the use of an additional component for each network device for storage of the configurations to existing neighboring devices or optionally to a server. As a result, costs can be saved.

At the same time, a potentially erroneous manual action of separating the additional components from network devices to be exchanged and reconnection with the exchanged device is avoided. The device to be exchanged must only be connected to the separate connections of the exchanged device in the same manner in order to be able to be identified with the claimed method and to be provided with a configuration.

Further features of the present invention will become apparent from the accompanying drawings. Therein:

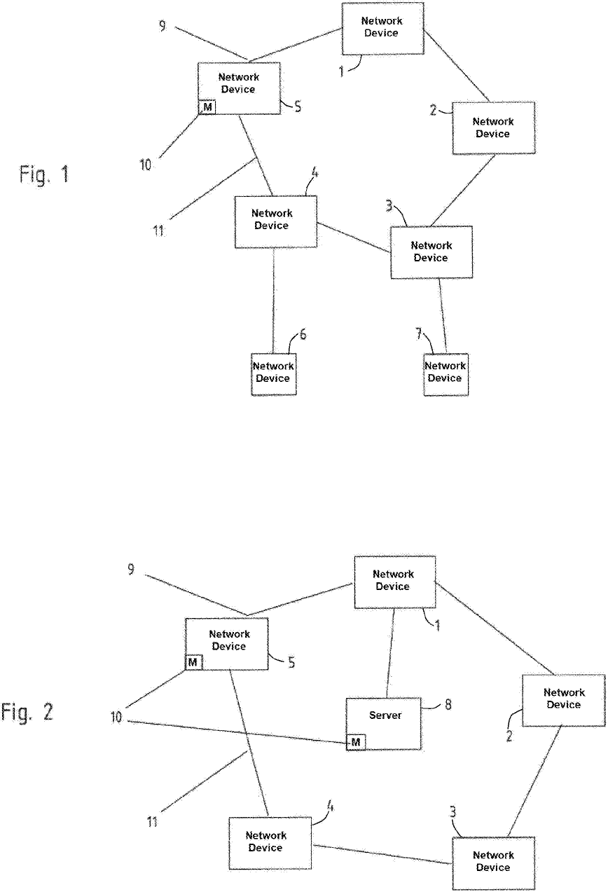

FIG. 1 shows a method according to the invention for distributing configurations in networks.

FIG. 2 shows a method according to the invention for distributing configurations in networks as in FIG. 1, but with an additional network device as a server.

FIG. 1 shows a network 11 for applying the method according to the invention for distributing the configuration of network devices 1, 2, 3, 4, 6, and 7. The network 11 shown is partly ring topology and partly star topology. However, in order to use the method according to the invention, it is not necessary to have a specific network topology. The method is applicable in all known networks,

In the network 11, the network devices 1, 2, 3, 4, 5, 6, and 7 are provided. The network connections themselves are implemented via ports 9, so that each network device 1, 2, 3, 4, 5, 6, and 7 could access any other network device 1, 2, 3, 4, 5, 6, and 7.

At least one network device 5 in FIG. 1 also has a memory 10. In this memory, data, for example files, can be stored and read out. The memory 10 is to be considered in addition to the local storage possibilities of each network device.

The network devices 1, 2, 3, 4, and 5 shown in FIG. 1 can be, for example, network routers or hubs, to which the two computers 6 and 7 are for example connected. However, the method is not limited to this type of network. Rather, all types of network devices can be used.

According to the method according to the invention, at least one network device 1, 2, 3, 4, 5, 6, or 7 is equipped with means for determining its location. This means of location determination ensures that the exact location in the network of the at least one network device 1,2,3, 4, 5, 6 or 7 is recorded.

The method according to the invention now proposes that the configuration of at least one of the network devices 1, 2, 3, 4, 5, 6, and 7 is stored in the memory 10 of another one of the network devices 1, 2, 3, 4, 5, 6 and 7 using the location determined by the location determination means. If, for example, the method for the network device 4 is to be executed, the location determination means determines the location of the network device 4 and stores the configuration of the network device 4 on the memory 10 of the network device 5.

In FIG. 1, only one 5 of the network devices 1, 2 ,3, 4, 5, 6, and 7 is equipped with a memory 10. However, more memory possibilities are also conceivable, as is shown, inter alia, in FIG. 2.

In order to be able to determine which network device 1, 2, 3, 4, 5,6, or 7 is provided with a memories 10 on which the configurations can be stored, rules for the method according to the invention can be defined. These rules then clearly define the memory 10 having to be accessed in order to store or read the configurations.

If the above-mentioned network device 4 then fails because it has a defect or shows other incorrect behavior, it must be exchanged for a structurally identical, factory-fresh device. Then, also using the above-mentioned method, the location of this new device is determined. Since no configuration is present in the new device, an attempt is made to find a corresponding configuration. For this purpose, the network device 4 to be configured is identified by the position determination as well as its associated configuration file, namely taking into account the position. This is read out of the corresponding memory 10 via the above-mentioned rules and is installed in the network device 4.

FIG. 2 shows, in addition to the other network devices 1, 2, 3, 4, and 5, a server 8 that also has a memory 10. Thus, a network 11 with two memories 10 is shown. Corresponding rules can now determine in which memory 10 the configurations are stored.

On the one hand, it would be conceivable for all the configurations to be stored on the server 8, as well as a distribution of configurations on a plurality of memories 10. This increases the availability of the configuration files in the entire system.

The present connection is not limited to the above-described features; rather, further embodiments are conceivable. Thus, instead of using the P2P protocol, it is possible to use an FTP protocol. Furthermore, it would be conceivable to equip all of the network devices with a memory, the claimed memory always being in addition to the local memory of the configuration. However, it is also conceivable for no local memory to be provided and to store the configuration files only centrally, for example on a server. However, when starting the network, all network devices would have to read the configuration from the server and apply them.

1. A method of distributing configurations of network devices (1, 2, 3, 4, 5, 6, 7, 8) with at least one network (11) to which network devices (1, 2, 3, 4, 5, 6, 7, 8) can be connected, at least two of network devices (1,2,3,4,5, 6, 7, 8) being connected via ports (9) to the network (11), where the network devices (1, 2, 3, 4, 5, 6, 7, 8) are provided with respective determinable unique identifications, at least one memory (10) being assigned to at least one network device (1, 2, 3, 4, 5, 6, 7, 8), characterized in that at least one network device (1, 2, 3, 4, 5, 6, 7, 8) has means for location determination that determines the location of the at least one of the network devices (1, 2, 3, 4, 5, 6, 7, 8) and that the configuration of the at least one network device (1, 2, 3, 4, 5, 6, 7, 8) is stored along with the location on the memory (10) in another one of the network devices (1, 2, 3, 4, 5, 6, 7, 8).

2. The method according to claim 1, characterized in that the configuration of the at least one network device (1, 2, 3, 4, 5, 6, 7, 8) is stored along with its location on a plurality of memories (10) of the other network devices (1, 2, 3, 4, 5, 6, 7, 8) .

3. The method according to claim 1, characterized in that the storage of the configuration of the at least one network device (1, 2, 3, 4, 5, 6, 7, 8) takes place with inclusion of the location on at least one memory (10) of other network devices (1,2,3, 4,5,8, 7, 8) according to definable rules.

4. The method according to claim 3, characterized in that as a rule the storage is in the memory (10) of the network device (1, 2, 3, 4, 5, 6, 7, 8) that itself in on the at least adjacent network devices (1, 2, 3, 4, 5, 6, 7, 8).

5. The method according to claim 3, characterized in that as a rule the storage is on the memory (10) of that network device that acts as a server (8) is set.

6. The method according to any one of claims 1 to 5, characterized in that the storage of the configuration of the at least one network device (1, 2, 3, 4, 5, 6, 7, 8) is performed using the location each time there is a configuration change.

7. The method according to one of claims 1 to 6, characterized in that the storage of the configuration of the at least one network device (1, 2, 3, 4, 5, 6, 7, 8) is carried out using the location according to a predetermined schedule.

8. The method according to one of claims 1 to 7, characterized in that, in the absence of a configuration of the at least one network device {1, 2, 3, 4, 5, 6, 7, 8) by the means, the location of the at least one network device (1, 2, 3, 4, 5, 6, 7, 8) is determined and the configuration of the at least one network device (1, 2, 3, 4, 5, 6, 7, 8) is loaded and applied by including the location from the memory of another one of the network devices (1, 2, 3, 4, 5, 6, 7, 8).

9. The method according to one of claims 1 to 8, characterized in that the characteristics of the adjacent network devices (1, 2, 3, 4, 5, 6, 7, 8) are determined for determining the location and are used as signaling keys.

10. The method according to claim 9, characterized in that ports (9) to which the adjacent network devices are connected are added to a character string.

11. The method according to claim 9 or 10, characterized in that the character string is encrypted by an algorithm, in particular by means of a hashing algorithm.

12. The method according to one of claims 1 to 11, characterized in that the storage of the configurations is carried out as a configuration file that can be encrypted and/or compressed.

13. The method according to one of claims 1 to 12, characterized in that parameters can be generated and displayed on at least one display in order to visualize the state of the network devices (1, 2, 3, 4, 5, 6, 7, 8) and/or their configurations.

14. The method according to one of claims 1 to 13, characterized in that the configuration of the at least one network device (1, 2, 3, 4, 5, 6, 7, 8) is not stored intact, but is distributed to a plurality of memories (10) of the further network devices (1, 2, 3, 4, 5, 6, 7, 8).

15. The method according to one of claims 1 to 14, characterized in that the configuration of the at least one network device (1,2,3, 4,5,8, 7, 8) is stored by a suitable point-to-point protocol (P2P).

16. The method according to one of claims 1 to 14, characterized in that the configuration of the at least one network device (1, 2, 3, 4, 5, 6, 7, 8) takes place via a suitable protocol with inclusion of the distance to the furthest network device (1,2,3, 4,5,8, 7, 8), on the memory where the configuration is to be stored.
